(19) United States
(12) Patent Application Publication
(10) Pub. No.: US 2025/0110199 A1
(43) Pub. Date: Apr. 3, 2025

(54) Systems and Methods for Filtering Improbable Locations

(71) Applicant: ZEBRA TECHNOLOGIES CORPORATION, Lincolnshire, IL (US)

(72) Inventors: Jason M. Gang, Plainview, NY (US); Andrew R. Calvarese, Stony Brook, NY (US); Paul Seiter, Port Jefferson Station, NY (US)

(21) Appl. No.: 18/374,246

(22) Filed: Sep. 28, 2023

(51) Int. Cl. G01S 5/02

(52) U.S. Cl. CPC G01S 5/02521; G01S 5/0244

(57) ABSTRACT

Systems and methods for filtering improbable locations are disclosed herein. An example system includes: a tag configured to transmit data while within one of a plurality of zones and a locationing engine. The locationing engine may be configured to: receive the data, analyze at least one property of the data to determine a current zone of the plurality of zones containing the tag with an associated confidence value, and analyze prior data transmitted from the tag to determine whether the current zone is different from a prior zone determined from the prior data. The locationing engine may also compare (i) a time differential between receipt of the prior data and receipt of the data and (ii) the associated confidence value with a cost value corresponding to moving from the prior zone to the current zone, and update a location of the tag based on the comparison.

### BACKGROUND

Digital technology is utilized in industrial networks for locationing services. More specifically, location data insight is a relevant component of entities seeking to track locations and statuses of their assets, enhance the productivity of their workers, and to generally optimize workflows. As such, development of systems and devices that reliably provide cost-effective, proximity-based asset visibility solutions are a topic of great interest in the field of industrial networking.

However, conventional locationing systems suffer from several drawbacks that prevent them from providing such reliable and effective locationing services. Namely, many conventional locationing systems rely on hardware that is sub-optimally located and can therefore produce inaccurate results, particularly when combined with the inherent jitteriness of shorter-range locationing. For example, a conventional hospital locationing system may utilize a single, stationary gateway in each room to track the locations of one or multiple tags. These individual gateways may be insufficient to accurately distinguish, for example, when a tag has moved from within the room to an adjacent hallway or room because the confidence level/signal strength associated with the tag's location remains relatively high in-between consecutive tag reports. Consequently, conventional locationing systems suffer from issues that minimize the accuracy and effectiveness of the systems to locate individual tags and the corresponding assets.

Thus, there is a need for systems and methods for filtering improbable locations that allows for fast and accurate data transmission within a locationing system.

### SUMMARY

In an embodiment, the present invention is a system comprising: a tag configured to transmit data while within one of a plurality of zones; and a locationing engine configured to: receive the data, analyze at least one property of the data to determine a current zone of the plurality of zones containing the tag with an associated confidence value, analyze prior data transmitted from the tag to determine whether the current zone is different from a prior zone determined from the prior data, compare (i) a time differential between receipt of the prior data and receipt of the data and (ii) the associated confidence value with a cost value corresponding to moving from the prior zone to the current zone, and update a location of the tag based on the comparison.

In a variation of this embodiment, the at least one property of the data includes a received signal strength indicator (RSSI) value, and the locationing engine is further configured to: determine the associated confidence value based on the RSSI value. Further in this variation, the locationing engine is further configured to: determine, for the tag, at least one of: (a) a number of different zone reports, (b) a number of consecutive zone reports for the current zone, or (c) a confidence value adjustment for the current zone based on the RSSI value; and adjust the associated confidence value based on one or more of (a)-(c).

In another variation of this embodiment, each zone of the plurality of zones is defined by one or more polylines in three-dimensional (3D) space, the location of the tag is a set of 3D coordinates within the 3D space, and the locationing engine is further configured to: compare the set of 3D coordinates with polylines of the current zone; determine that the set of 3D coordinates is bounded by the polylines of the current zone; and determine that the tag is located within the current zone.

In yet another variation of this embodiment, the cost value is an average travel time from the prior zone to the current zone.

In still another variation of this embodiment, the locationing engine is further configured to: reduce the cost value based on a respective confidence value associated with the tag being located within the prior zone; and update the location of the tag based on reducing the cost value and the comparison.

In yet another variation of this embodiment, the locationing engine is further configured to: establish a set of checkpoints corresponding to the plurality of zones; compare (i) the time differential, (ii) the associated confidence value, and (iii) the set of checkpoints with the cost value; and update the location of the tag based on the comparison. Further in this variation, each checkpoint of the set of checkpoints represents an intermediate travel path for transitioning between zones of the plurality of zones.

In still another variation of this embodiment, the prior zone has a free movement area along a perimeter of the prior zone, and the locationing engine is further configured to: determine that the tag moved between the prior zone and the current zone through the free movement area; eliminate the cost value; and update the location of the tag based on the associated confidence value.

In another embodiment, the present invention is a computer-implemented method comprising: receiving data from a tag configured to transmit data while within one of a plurality of zones; analyzing at least one property of the data to determine a current zone of the plurality of zones containing the tag with an associated confidence value; analyzing prior data transmitted from the tag to determine whether the current zone is different from a prior zone determined from the prior data; comparing (i) a time differential between receipt of the prior data and receipt of the data and (ii) the associated confidence value with a cost value corresponding to moving from the prior zone to the current zone; and updating a location of the tag based on the comparison.

In a variation of this embodiment, the at least one property of the data includes a received signal strength indicator (RSSI) value, and the method further comprises: determining the associated confidence value based on the RSSI value. Further in this variation, the computer-implemented method further comprises: determining, for the tag, at least one of: (a) a number of different zone reports, (b) a number of consecutive zone reports for the current zone, or (c) a confidence value adjustment for the current zone based on the RSSI value; and adjusting the associated confidence value based on one or more of (a)-(c).

In another variation of this embodiment, each zone of the plurality of zones is defined by one or more polylines in three-dimensional (3D) space, the location of the tag is a set of 3D coordinates within the 3D space, and the method further comprises: comparing the set of 3D coordinates with polylines of the current zone; determining that the set of 3D coordinates is bounded by the polylines of the current zone; and determining that the tag is located within the current zone.

In yet another variation of this embodiment, the cost value is an average travel time from the prior zone to the current zone.

In still another variation of this embodiment, the computer-implemented method further comprises: reducing the cost value based on a respective confidence value associated with the tag being located within the prior zone; and updating the location of the tag based on reducing the cost value and the comparison.

In yet another variation of this embodiment, the computer-implemented method further comprises: establishing a set of checkpoints corresponding to the plurality of zones; comparing (i) the time differential, (ii) the associated confidence value, and (iii) the set of checkpoints with the cost value; and updating the location of the tag based on the comparison.

In still another variation of this embodiment, the prior zone has a free movement area along a perimeter of the prior zone, and the method further comprises: determining that the tag moved between the prior zone and the current zone through the free movement area; eliminating the cost value; and updating the location of the tag based on the associated confidence value.

In yet another embodiment, the present invention is a tangible machine-readable medium comprising instructions that, when executed, cause a machine to at least: receive data from a tag configured to transmit data while within one of a plurality of zones; analyze at least one property of the data to determine a current zone of the plurality of zones containing the tag with an associated confidence value; analyze prior data transmitted from the tag to determine whether the current zone is different from a prior zone determined from the prior data; compare (i) a time differential between receipt of the prior data and receipt of the data and (ii) the associated confidence value with a cost value corresponding to moving from the prior zone to the current zone; and update a location of the tag based on the comparison.

In a variation of this embodiment, the at least one property of the data includes a received signal strength indicator (RSSI) value, and the instructions, when executed, further cause the machine to at least: determine the associated confidence value based on the RSSI value.

In another variation of this embodiment, the cost value is an average travel time from the prior zone to the current zone, and the instructions, when executed, further cause the machine to at least: reduce the cost value based on a respective confidence value associated with the tag being located within the prior zone; and update the location of the tag based on reducing the cost value and the comparison.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 depicts an example environment in which systems/devices for filtering improbable locations may be implemented, in accordance with embodiments described herein.

FIG. 2A depicts a server transmitting requests to an anchor and causing the anchor to poll a proximate tag at multiple time instances so the locationing engine may track the tag's location over time, in accordance with embodiments described herein.

FIG. 2B depicts an improbable location filtering process for signals from asset tags performed by a locationing engine, in accordance with embodiments described herein.

FIG. 3 is a flowchart representative of a method for filtering improbable locations, in accordance with embodiments described herein.

FIG. 4 is a block diagram of an example logic circuit for implementing example methods and/or operations described herein.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

As previously mentioned, conventional locationing systems generally suffer from accuracy issues stemming from, inter alia, insufficiently placed/located hardware and a corresponding lack of improbable location suppression. For example, many conventional locationing systems utilize a received signal strength indicator (RSSI) to determine a likely location for a reporting tag. However, these RSSI values, and the resulting confidence values, may fail to adequately account for practical realities when tracking movement.

To illustrate, a first conventional gateway may receive a data packet from a tag suggesting that, when compared with the prior location of the tag, the tag moved through a wall in a short timeframe (e.g., milliseconds) to reach the tag's current location. This situation is unlikely and should be disregarded and/or otherwise suppressed in favor of a more likely scenario in which the current location of the tag does not suggest such an unlikely sequence of events when compared to the tag's prior location. Nevertheless, conventional locationing systems may provide such misreports of tag locations when RSSI values (and corresponding confidence values) corresponding to unlikely/impossible event sequences are high/strong, regardless of such practical limitations. Thus, in general, conventional locationing systems can struggle to accurately perform locationing.

Thus, it is an objective of the present disclosure to eliminate these and other problems with conventional locationing systems via systems and methods that may filter improbable locations through a locationing engine configured to consider/apply various cost values when analyzing data received from tags. In particular, the systems and methods of the present disclosure alleviate the issues present with conventional systems/devices by comparing time differentials between data receipts from tags and confidence values with such cost values. As a result, the systems and methods of the present disclosure accurately determine the location of a tag/asset at any given time with an accuracy that was previously unachievable using conventional techniques.

Thus, in accordance with the above, and with the disclosure herein, the present disclosure includes improvements in computer functionality or in improvements to other technologies at least because the present disclosure describes that, e.g., locationing systems, and their related various components, may be improved or enhanced with the disclosed location suppressing/filtering systems and methods that provide more accurate locationing services for tags and corresponding assets. That is, the present disclosure describes improvements in the functioning of a locationing system itself or “any other technology or technical field” (e.g., the field of distributed/industrial locationing systems) because the disclosed location suppressing/filtering systems and methods improve and enhance operation of locationing systems by introducing improved data packet confidence value analysis to eliminate/reduce erroneous location determinations and other inefficiencies typically experienced over time by locationing systems lacking such location suppressing/filtering systems and methods. This improves the state of the art at least because such previous locationing systems are inaccurate as they lack the ability for analyzing received data packets in the manners described herein.

In addition, the present disclosure includes applying various features and functionality, as described herein, with, or by use of, a particular machine, e.g., a tag, an anchor/gateway, a server, and/or other hardware components as described herein.

Moreover, the present disclosure includes specific features other than what is well-understood, routine, conventional activity in the field, or adding unconventional steps that demonstrate, in various embodiments, particular useful applications, e.g., analyze at least one property of the data to determine a current zone of the plurality of zones containing the tag with an associated confidence value; analyze prior data transmitted from the tag to determine whether the current zone is different from a prior zone determined from the prior data; compare (i) a time differential between receipt of the prior data and receipt of the data and (ii) the associated confidence value with a cost value corresponding to moving from the prior zone to the current zone; and/or update a location of the tag based on the comparison, among others.

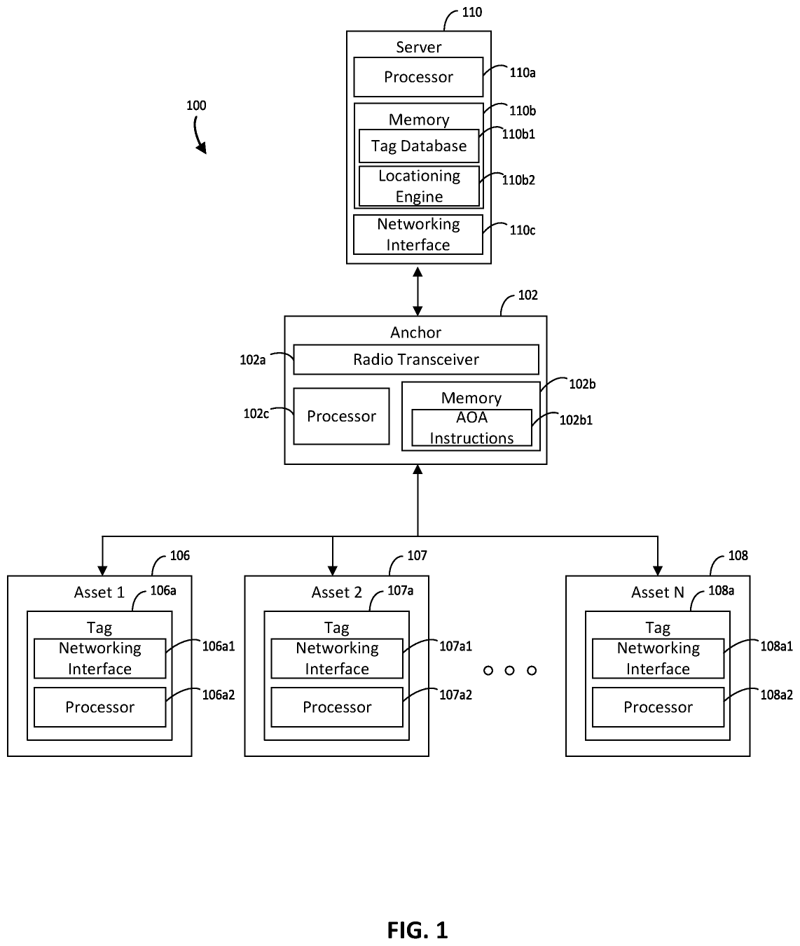

Turning to the figures, FIG. 1 depicts an example environment 100 in which systems/devices for filtering improbable locations may be implemented, in accordance with embodiments described herein. The example environment 100 may comprise, include, and/or otherwise be a part of a networking environment in which the systems/devices of the present disclosure may operate. In the example embodiment of FIG. 1, the example environment 100 includes an anchor 102 that is communicatively coupled to a first tag 106a of a first asset 106, a second tag 107a of a second asset 107, a third tag 108a of an N^{th} asset 108, and a server 110. Generally speaking, the anchor 102, the first tag 106a, the second tag 107a, the third tag 108a, and/or the server 110 may be capable of executing instructions to, for example, implement operations of the example methods described herein, as may be represented by the flowcharts of the drawings that accompany this description. Namely, the anchor 102 may be connected to the first tag 106a, the second tag 107a, the third tag 108a, and/or the server 110 across multiple communication channels, and may generally be configured to receive and process information received from the first tag 106a, the second tag 107a, the third tag 108a, and/or the server 110.

The server 110 may store a tag database 110b1 and a locationing engine 110b2. The tag database 110b1 may be or include a listing of tags (e.g., tag 106a, tag 107a, tag 108a) that are proximate to specific anchors (e.g., anchor 102) and/or otherwise transmit data to the particular anchor(s). More specifically, the tag database 110b1 listings may include identification information about each of the tags 106a, 107a, 108a and/or the assets 106, 107, 108 associated with the tags 106a, 107a, 108a, as well as location information (e.g., angle of arrival (AOA)) determined by the anchor 102. The tag database 110b1 may include any suitable information related to the tags and/or the assets associated with the tags.

To update the tag database 110b1, the server 110 may periodically request and/or otherwise receive updates from various anchors (e.g., anchor 102) disposed around an environment (e.g., example environment 100), and the server 110 may determine (via the one or more processors 110a) one or more tags indicated in the data received from the various anchors. The server 110 may then update the tag listing for each anchor by inputting each tag identified in the data received from the respective anchors into the corresponding tag listing of the tag database 110b1. For example, the tag database 110b1 may indicate at a first time that the anchor 102 received data from the first tag 106a and the second tag 107a. At a second time, the server 110 may transmit a request to the anchor 102 and/or may otherwise receive an update from the anchor 102 indicating that the anchor 102 received data from the first tag 106a, the second tag 107a, and the third tag 108a. Thus, the entries of the tag database 110b1 may indicate that the N^{th} asset 108 moved into a receptive proximity of the anchor 102 at some point between the first time and the second time, such that the anchor 102 was able to receive data transmitted from the third tag 108a at the second time.

The server 110 may also include a locationing engine 110b2, which may generally analyze data received from the tags 106a, 107a, 108a to update locations of the tags 106a, 107a, 108a. More specifically, the locationing engine 110b2 may analyze data packets and/or information extracted and/or otherwise derived from the data packets to determine a current zone in which each tag 106a, 107a, 108a is currently located. Such data packets may generally be or include identification information corresponding to the tags 106a, 107a, 108a and/or the associated assets 106, 107, 108, remaining battery life information, asset-specific data payloads, and/or any other suitable data or combinations thereof. The tags 106a, 107a, 108a may transmit such data packets at any suitable transmission rate such as every millisecond, several milliseconds, every second, several seconds, minutes, etc. In certain embodiments, data packets transmitted by any particular tag 106a, 107a, 108a may be or include a Bluetooth low energy (BLE) data packet, such as a BLE continuous tone extension (CTE) data packet.

Moreover, the “zones” referenced herein may generally correspond to any suitable regions within and/or otherwise defined by a specific location within any suitable area of interest. For example, an area of interest may be a hospital, and the zones corresponding to the hospital may be individual rooms within the hospital. As another example, an area of interest may be a warehouse and the zones within the warehouse may correspond to individual loading docks, storage areas, movement pathways for equipment/machinery, etc. In certain embodiments, each zone may be defined by one or more polylines in three-dimensional (3D) space, and the location of each tag may be a set of 3D coordinates within the 3D space. Further, each of these zones may be predetermined as part of the instructions comprising the locationing engine 110b2 and/or may be determined by the locationing engine 110b2 during locationing system configuration based on signals received from tags 106a, 107a, 108a and anchor(s) 102.

When the locationing engine 110b2 determines the current zone for a particular tag, the locationing engine 110b2 may also analyze prior data transmitted from the particular tag to determine whether the current zone is different from a prior zone determined from the prior data. For example, the locationing engine 110b2 may receive data from a first tag and determine that the first tag is estimated to be in a first zone. The locationing engine 110b2 may then analyze prior data corresponding to the first tag (e.g., as stored in the tag database 110b1) and determine that the last report from the first tag indicated that the first tag was located in a second (e.g., prior) zone at the time the last report was transmitted from the first tag. Consequently, the locationing engine 110b2 may determine that the first tag has changed location from the second zone to the first zone during the time interval that elapsed between the last report and the current report from the first tag.

As another example, the locationing engine 110b2 may receive data from a second tag and determine that the second tag is estimated to be in a third zone. The locationing engine 110b2 may then analyze prior data corresponding to the second tag (e.g., as stored in the tag database 110b1) and determine that the last report from the second tag indicated that the second tag was located in the third zone at the time the last report was transmitted from the second tag. Consequently, the locationing engine 110b2 may determine that the second tag has remained in the third zone during the time interval that elapsed between the last report and the current report from the second tag.

The locationing engine 110b2 may also compare time differentials between reporting instances in combination with confidence values and cost values of the received data to determine whether such changes (or no changes) are probable. The time differentials may be milliseconds, seconds, and/or any other suitable length of time that elapses between respective data packet transmissions (termed “reports” or “zone reports” herein) from an individual tag. Such respective data packet transmissions may be consecutive or non-consecutive, based on, for example, the cost values utilized by the locationing engine 110b2. The confidence values may represent an expected/estimated accuracy of a zone in which the tag is located based on the data packet received from the tag and may be based on RSSI and/or any other suitable metric. Moreover, the cost values may be or include an average travel time from a prior zone to a current zone, and/or may be or include any other suitable costs or values associated with travel between any respective pair or collection of zones.

For example, a third tag may report to the anchor 102 at a first time instance and at a second time instance five milliseconds after the first time instance. The anchor 102 may transmit the data packets corresponding to the first time instance reporting and the second time instance reporting and/or any other suitable information to the server 110 where the server 110 executes the locationing engine 110b2 to analyze the data packets and/or any other suitable information. After the first time instance, the locationing engine 110b2 may determine that the third tag was located in a first zone at the first time instance and may store this information in the tag database 110b1. The locationing engine 110b2 may later analyze the information from the second time instance (referenced in this example as the “first data packet”) and determine that the third tag was located in a second zone. Thus, the locationing engine 110b2 may access the tag database 110b1 to determine that the third tag has moved from the first zone to the second zone during the five millisecond time differential between the first time instance and the second time instance.

Furthering this example, the locationing engine 110b2 may also analyze the confidence value for the data packets received during the second time instance and/or the first time instance and may impose cost values against the confidence values to determine whether the movement from the first zone to the second zone is probable. The first zone may be eight meters from the second zone, such that the average travel time from the first zone to the second zone is approximately twelve seconds. Thus, the cost value associated with moving from the first zone to the second zone may be approximately twelve seconds, such that the locationing engine 110b2 may determine that the confidence value associated with the third tag currently being located in the second zone should be lowered significantly. In other words, it is highly unlikely that the third tag actually moved from the first zone to the second zone in five milliseconds or less when the average travel time between those zones is approximately twelve seconds.

Continuing this example, the locationing engine 110b2 may have concurrently received a second data packet and/or other suitable information corresponding to the third tag indicating that the third tag is currently located in the first zone. This second data packet may initially have a lower confidence value than the first data packet indicating the third tag is located in the second zone, but the locationing engine 110b2 may apply cost values discussed previously to these confidence values to determine the more probable location for the third tag. As the second data packet indicates that the third tag remained in the first zone during the time period between the first time instance and the second time instance, the locationing engine 110b2 may not apply any cost value to the confidence value for the second data packet. Accordingly, the locationing engine 110b2 may lower the confidence value for the first data packet below the confidence value for the second data packet, and the locationing engine 110b2 may ultimately determine that the third tag is located in the first zone, as indicated by the second data packet received at the second time instance.

As part of these communications between the server 110 and the individual tags 106a, 107a, 108a, the anchor 102 may receive data from the server 110 and the tags 106a, 107a, 108a, and may transmit communications based on that received data to the server 110 and/or the tags 106a, 107a, 108a. Broadly speaking, the anchor 102 may be configured to transmit and receive data to/from the server 110 and nearby tags (e.g., the first tag 106a, the second tag 107a, the third tag 108a). In certain embodiments, the anchor 102 may be a hybrid Bluetooth® low energy (BLE) device that communicates with some/all of the devices in the environment 100 via BLE. In some embodiments, the anchor 102 may be a device that executes and/or conforms to any suitable software operating system (e.g., Android, IOS), a custom Internet of Things (IoT) bridge device with a BLE radio, and/or any other suitable device or combination thereof.

Namely, the anchor 102 may be configured to periodically listen for data packets from nearby tags (e.g., tags 106a, 107a, 108a), transmit the data packets and/or data obtained therein to the server 110, and/or broadcast requests received from the server 110 to such nearby tags. As an example, the anchor 102 may receive requests from the server 110, and may subsequently transmit requests to proximate tags 106a, 107a, 108a based on the requests. Such requests from the server 110 may be or include instructions causing the tags 106a, 107a, 108a to transmit identification data to the anchor 102 and/or other suitable instructions or combinations thereof.

The anchor 102 may also transmit and receive data (e.g., data packets) to/from any of the tags 106a, 107a, 108a and to calculate an AOA based on the data received from those tags 106a, 107a, 108a by executing the AOA instructions 102b1 stored in memory 102b. The anchor 102 may then transmit these AOAs, along with some/all of the received data from the tags 106a, 107a, 108a, to the server 110 for tracking and/or otherwise notifying a user (e.g., a locationing system administrator) of a location/position of an asset 106, 107, 108 associated with the tags 106a, 107a, 108a.

Generally, the AOA instructions 102b1 may be or include instructions enabling the processors 102c of the anchor 102 to determine the AOA of data packets received from any individual tag 106a, 107a, 108a. For example, the AOA instructions 102b1 may enable the anchor 102 to define a two-dimensional plane within a zone containing any particular tag 106a, 107a, 108a, calculate the AOA of the tag's data packets, determine a vector corresponding to the AOA, and calculate the position of the associated tag based on an intersection of the vector with the two-dimensional plane. It should be appreciated that the AOA instructions 102b1 may be or include any suitable instructions that enable the anchor 102 and/or any other suitable device(s) (e.g., server 110) to calculate an AOA or otherwise location of proximate tags and their corresponding assets.

The anchor 102 may also include a radio transceiver 102a configured to transmit/receive data streams to/from various devices of the example environment 100, such as the server 110 and the tags 106a, 107a, 108a. The radio transceiver 102a may include an antenna with an associated gain profile corresponding to the transceiver's 102a antenna converting input power into radio waves (e.g., transmission) and/or received radio waves into electrical power (e.g., receiving).

The assets 106, 107, 108 may generally be any device, component, or object that an entity may desire to track and/or otherwise locate. For example, the assets 106, 107, 108 may be large and calibrated tools used in and/or for oil and gas equipment/operations, parcels for delivery by a shipping company, hospital equipment that is and/or may be moved to different floors/rooms, wristbands attached to hospital patients, and/or any other suitable objects or combinations thereof. While illustrated as three assets 106, 107, 108, it should be appreciated that the anchor 102 may simultaneously communicate with any suitable number of assets 106, 107, 108 via the associated tags 106a, 107a, 108a. Thus, the N^{th} asset 108 may be a third asset, a fifth asset, a twentieth asset, a one-hundredth asset, and/or any other integer value asset.

Each asset 106, 107, 108 may also include a corresponding tag 106a, 107a, 108a that may be configured to transmit information associated with the asset via the networking interface 106a1, 107a1, 108a1 to, for example, the anchor 102. Each asset tag 106a, 107a, 108a may also include one or more processors 106a2, 107a2, 108a2 configured to interpret and/or execute instructions contained in signal received from the anchor 102, server 110, and/or other suitable device(s). For example, the processors 106a2, 107a2, 108a2 may be configured to interpret polling requests received from the anchor 102 and thereby transmit data packets to the anchor 102.

Moreover, in certain embodiments, a workstation (not shown) may be communicatively connected to the server 110, and a user/operator may access the server 110 to retrieve a location associated with an asset 106, 107, 108. The workstation may query the server 110 with the identification tag of the corresponding asset 106, 107, 108, and the server 110 may match the identification tag with a location entry in the tag database 110b1 associated with the corresponding asset 106, 107, 108. The server 110 may then forward the location entry to the workstation for viewing by the user/operator.

More generally, the one or more memories 102b, 110b may include one or more forms of volatile and/or non-volatile, fixed and/or removable memory, such as read-only memory (ROM), electronic programmable read-only memory (EPROM), random access memory (RAM), erasable electronic programmable read-only memory (EEPROM), and/or other hard drives, flash memory, MicroSD cards, and others. In general, a computer program or computer based product, application, or code (e.g., locationing engine 110b2, AOA instructions 102b1, and/or other computing instructions described herein) may be stored on a computer usable storage medium, or tangible, non-transitory computer-readable medium (e.g., standard random access memory (RAM), an optical disc, a universal serial bus (USB) drive, or the like) having such computer-readable program code or computer instructions embodied therein, wherein the computer-readable program code or computer instructions may be installed on or otherwise adapted to be executed by the one or more processors 102c, 110a (e.g., working in connection with a respective operating system in the one or more memories 102b, 110b) to facilitate, implement, or perform the machine readable instructions, methods, processes, elements or limitations, as illustrated, depicted, or described for the various flowcharts, illustrations, diagrams, figures, and/or other disclosure herein.

In this regard, the program code may be implemented in any desired program language, and may be implemented as machine code, assembly code, byte code, interpretable source code or the like (e.g., via Golang, Python, C, C++, C #, Objective-C, Java, Scala, ActionScript, JavaScript, HTML, CSS, XML, etc.). Moreover, the one or more memories 102b, 110b may also store machine readable instructions, including any of one or more application(s), one or more software component(s), and/or one or more APIs, which may be implemented to facilitate or perform the features, functions, or other disclosure described herein, such as any methods, processes, elements or limitations, as illustrated, depicted, or described for the various flowcharts, illustrations, diagrams, figures, and/or other disclosure herein.

The one or more processors 102c, 110a may be connected to the one or more memories 102b, 110b via a computer bus (not shown) responsible for transmitting electronic data, data packets, or otherwise electronic signals to and from the one or more processors 102c, 110a and one or more memories 102b, 110b to implement or perform the machine readable instructions, methods, processes, elements or limitations, as illustrated, depicted, or described for the various flowcharts, illustrations, diagrams, figures, and/or other disclosure herein.

The one or more processors 102c, 110a may interface with the one or more memories 102b, 110b via the computer bus to execute any suitable application or executable instructions (e.g., locationing engine 110b2, AOA instructions 102b2) necessary to perform any of the actions associated with the methods of the present disclosure. The one or more processors 102c, 110a may also interface with the one or more memories 102b, 110b via the computer bus to create, read, update, delete, or otherwise access or interact with the data stored in the one or more memories 102b, 110b and/or external databases (e.g., a relational database, such as Oracle, DB2, MySQL, or a NoSQL based database, such as MongoDB). The data stored in the one or more memories 102b, 110b and/or an external database may include all or part of any of the data or information described herein, including, for example, asset tag 106a, 107a, 108a data packets, asset location data, AOA data, and/or other suitable information or combinations thereof.

The radio transceiver 102a and the networking interfaces 106a1, 107a1, 108a1 may be configured to communicate (e.g., send and receive) data via one or more external/network port(s) to one or more networks or local terminals, as described herein. In some embodiments, radio transceiver 102a and/or the networking interfaces 106a1, 107a1, 108a1 may include a client-server platform technology such as ASP.NET, Java J2EE, Ruby on Rails, Node.js, a web service or online API, responsive for receiving and responding to electronic requests. The radio transceiver 102a and/or the networking interfaces 106a1, 107a1, 108a1 may implement the client-server platform technology that may interact, via the computer bus, with the one or more memories 102b, 110b (including the applications(s), component(s), API(s), data, etc. stored therein) to implement or perform the machine readable instructions, methods, processes, elements or limitations, as illustrated, depicted, or described for the various flowcharts, illustrations, diagrams, figures, and/or other disclosure herein.

According to some embodiments, the radio transceiver 102a and the networking interfaces 106a1, 107a1, 108a1 may include, or interact with, one or more transceivers (e.g., WWAN, WLAN, and/or WPAN transceivers) functioning in accordance with IEEE standards, 3GPP standards, or other standards, and that may be used in receipt and transmission of data via external/network ports connected to a network. In some embodiments, the network (not shown) may comprise a private network or local area network (LAN). Additionally, or alternatively, the network may comprise a public network such as the Internet. In some embodiments, the network may comprise routers, wireless switches, or other such wireless connection points communicating to anchor 102 (via the radio transceiver 102a), the first asset 106 (via networking interface 106a1), the second asset (via networking interface 107a1), the third asset (via networking interface 108a1), and/or the server 110 (via networking interface 110c) via wireless communications based on any one or more of various wireless standards, including by non-limiting example, a BLUETOOTH standard (e.g., BLE), IEEE 802.11a/b/c/g (WIFI), or the like.

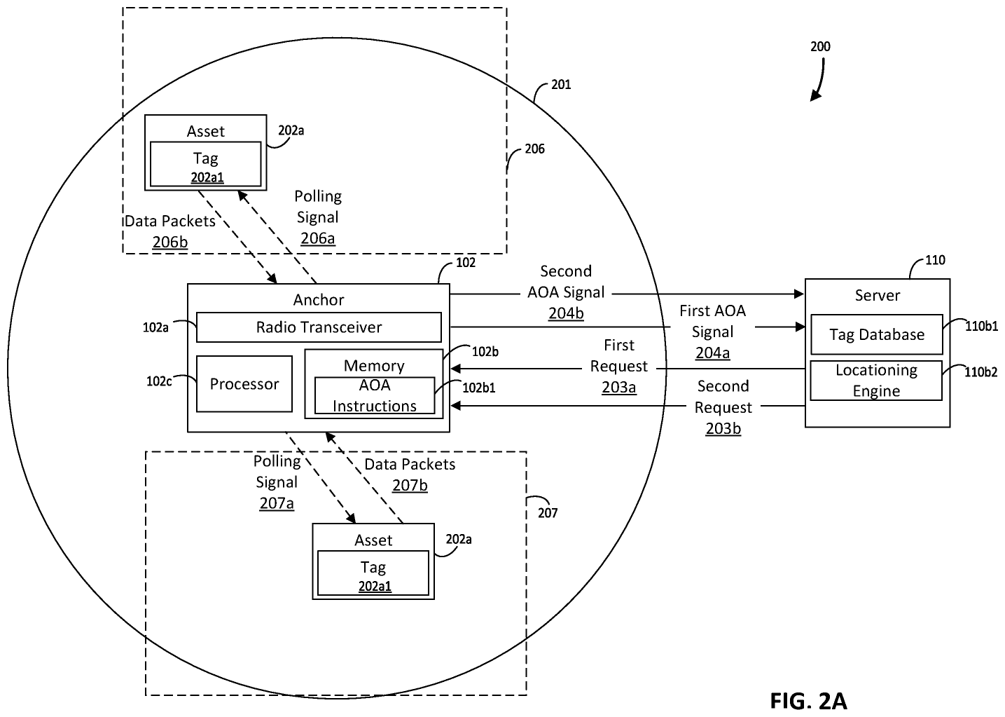

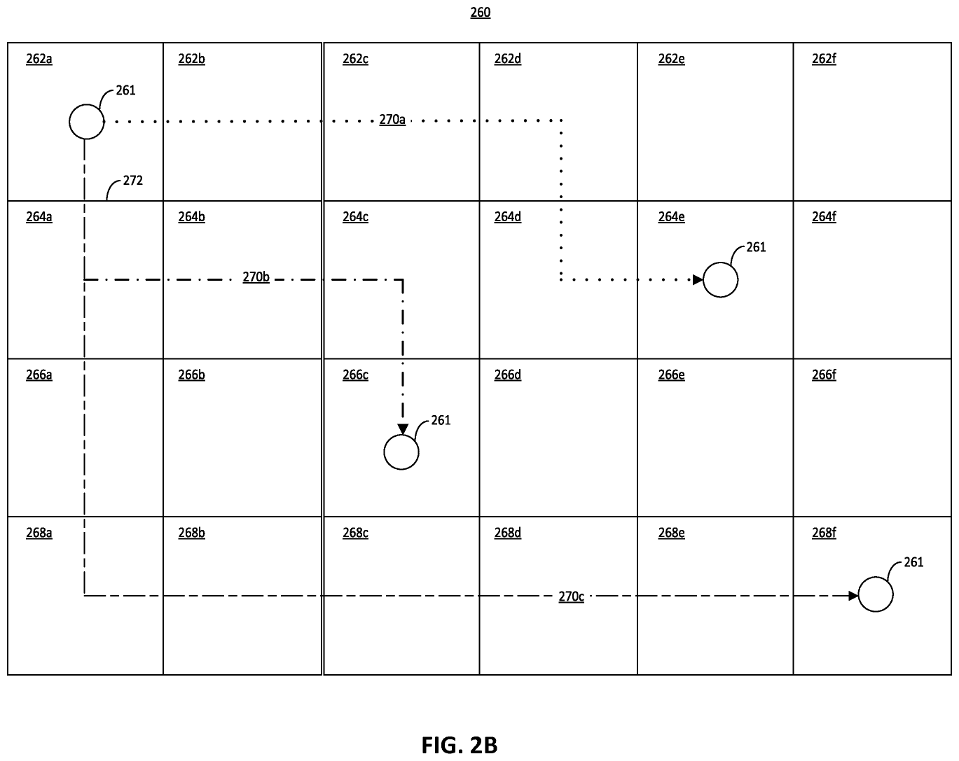

To illustrate a scenario where a server, anchor, and asset tag(s) may transmit and/or receive data packets and filter improbable locations from those data packets, FIG. 2A depicts a server 110 transmitting a request to an anchor 102 that causes the anchor 102 to poll a tag 202a1 associated with an asset 202a, in accordance with embodiments described herein. In particular, the example scenario 200 illustrated in FIG. 2A depicts the server 110 transmitting a first request 203a to the anchor 102 at a first time instance and the server 110 transmitting a second request 203b to the anchor 102 at a second time instance. The anchor 102 may then transmit a polling signal 206a to the tag 202a1 associated with the asset 202a at the first time instance, the tag 202a1 may transmit a data packet 206b to the anchor 102, and the anchor 102 may transmit an first AOA signal 204a to the server 110. Similarly, the anchor 102 may also transmit a polling signal 207a to the tag 202a1 associated with the asset 202a at the second time instance, the tag 202a1 may transmit a data packet 207b to the anchor 102, and the anchor 102 may transmit a second AOA signal 204b to the server 110. The locationing engine 110b2 may then compare the data packets 206b, 207b and/or other information included as part of the AOA signals 204a, 204b to determine the location of the tag 202a1.

As referenced herein, the asset 202a may be a “proximate asset” because the asset 202a is located within a transmission range 201 of the anchor 102. Thus, the proximate asset 202a (and the corresponding tag 202a1) may be physically close enough to the anchor 102 to receive and transmit signals (e.g., polling signals, data packets) to/from the anchor 102.

As an example, the anchor 102 may be located in a hospital hallway and the asset 202a may be a wristband of a patient currently located in a first hospital room, represented by the first zone 206. At the first time instance, the first asset 202a tag 202a1 may receive the polling signal 206a from the anchor 102 requesting a data packet transmission from the tag 202a1. The tag 202a1 may then transmit the data packets 206b to the anchor 102, where the anchor 102 determines an AOA and/or other location of the tag 202a1 within the transmission range 201 of the anchor 102. The anchor 102 may transmit the first AOA signal 204a to the server 110, where the server 110 may validate and/or store the location of the tag 202a1 in the tag database 110b1.

At the second time instance, the first asset 202a tag 202a1 may receive the polling signal 207a from the anchor 102 requesting a data packet transmission from the tag 202a1. The tag 202a1 may then transmit the data packets 207b to the anchor 102, where the anchor 102 determines an AOA and/or other location of the tag 202a1 within the transmission range 201 of the anchor 102. The anchor 102 may transmit the second AOA signal 204b to the server 110, where the server 110 may execute instructions comprising the locationing engine 110b2 to validate the location of the tag 202a1 indicated in the second AOA signal 204b.

More specifically, at the second time instance, the second AOA signal 204b may indicate that the tag 202a1 has moved from the first zone 206 to the second zone 207. The second zone 207 may represent, for example, a second hospital room across the hallway from the first hospital room represented by the first zone 206. In any event, the locationing engine 110b2 may compare the time differential between the first time instance and the second time instance and the confidence value associated with the second AOA signal 204b with any cost values associated with moving from the first zone 206 to the second zone 207. The cost value associated with moving from the first zone 206 to the second zone 207 may be six seconds, the time differential between the first time instance (e.g., associated with first request 203a, polling signal 206a, data packets 206b, and first AOA signal 204a) and the second time instance (e.g., associated with second request 203b, polling signal 207a, data packets 207b, and second AOA signal 204b) may be one second, the confidence value associated with the first AOA signal 204a may be relatively low, and the confidence value associated with the second AOA signal 204b may be relatively high.

Continuing this example, the locationing engine 110b2 may determine that the one second time differential between the first time instance and the second time instance is less than the six second cost value corresponding to moving between the first zone 206 and the second zone 207, such that the confidence value for the second AOA signal 204b should be adjusted (in this case, reduced) according to the cost value. However, the locationing engine 110b2 may also determine that the relatively low confidence value of the first AOA signal 204a is lower than the cost value-adjusted confidence value for the second AOA signal 204b and/or is otherwise sufficiently low to cause the locationing engine 110b2 to determine that the tag 202a1 is likely located in the second zone 207. In other words, because the tag 202a1 was unlikely to be located in the first zone 206 at the first time instance, the locationing engine 110b2 may discount and/or otherwise mitigate the impact of the cost value as applied to the confidence value of the second AOA signal 204b. As a result, the locationing engine 110b2 may update the location of the tag 202a1 at the second time instance as the second zone 207 and/or may revise the location of the tag 202a1 at the first time instance based on any other AOA signals corresponding to the tag 202a1 that may have been received at the first time instance.

Moreover, in certain embodiments, the locationing engine 110b2 may evaluate the confidence values of AOA signals for the tag 202a1 based on any suitable number of zone reports, consecutive zone reports for a particular zone, and/or RSSI values. For example, the asset 202a may be a piece of medical equipment and the first zone 206 may be a storage closet. The second AOA signal 204b at the second time instance may indicate that the medical equipment is located in the second zone 207 (e.g., a patient room), and the tag 202a1 may have also transmitted thousands of prior AOA signals (including first AOA signal 204a) indicating that the medical equipment is located in the first zone 206. In these embodiments, the locationing engine 110b2 may adjust the confidence value of the second AOA signal 204b indicating that the tag 202a1 is currently located in the second zone 207 to reflect that the tag 202a1 is more likely still in the first zone 206 because it is unlikely that the medical equipment has been removed from the storage closet and placed in a patient's room.

To provide a better understanding of various factors considered by the locationing engine 110b2 when performing locationing analysis, FIG. 2B depicts an improbable location filtering process for signals from asset tags performed by a locationing engine, in accordance with embodiments described herein. As illustrated in FIG. 2B, the improbable location filtering process may be depicted by a zone map 260 including a plurality of zones 262a-f, 264a-f, 266a-f, 268a-f. An asset tag 261 may initially be located in a first zone 262a and the asset tag 261 may move from the first zone 262a to another of the zones 262b-f, 264a-f, 266a-f, 268a-f indicated by the zone map 260. More specifically, the asset tag 261 may move from the first zone 262a, and the server (not shown) may receive AOA signals during a subsequent zone reporting period for the asset tag 261 indicating that the asset tag 261 is potentially located in each of zones 264e, 266c, and 268f.

In the zone map 260 of FIG. 2B, each of the potential locations may have corresponding paths 270a, 270b, 270c which the asset tag 261 may have taken (or may necessarily have taken) to reach the respective zones 264e, 266c, 268f. In particular, the locationing engine 110b2 may determine that the asset tag 261 followed the path 270a to move from the first zone 262a to the second zone 264e, the asset tag 261 followed the path 270b to move from the first zone 262a to the third zone 266c, and the asset tag 261 followed the path 270c to move from the first zone 262a to the fourth zone 268f.

In the example illustrated in FIG. 2B, the time differential between the zone report corresponding to the asset tag 261 being located in the first zone 262a and the zone report corresponding to the asset tag 261 potentially being located in the zones 264e, 266c, and 268f may be three seconds. The confidence values corresponding to the AOA signals indicating the asset tag 261 being located in each of the zones 264e, 266c, and 268f may be approximately equal. The cost value to move from the first zone 262a to the second zone 264e along the first path 270a may be five seconds, the cost value to move from the first zone 262a to the third zone 266c along the second path 270b may be three seconds, and the cost value to move from the first zone 262a to the fourth zone 268f along the third path 270c may be ten seconds. Thus, the locationing engine 110b2 may apply these cost values to the confidence values of the respective AOA signals to determine that the fourth zone 268f and the second zone 264e are unlikely/improbable locations for the asset tag 261. Based on this filtering of the improbable locations (e.g., second zone 264e, fourth zone 268f), the locationing engine 110b2 may further determine that the third zone 266c is the appropriate updated location for the asset tag 261.

In certain instances, the locationing engine 110b2 may include additional/alternative factors when determining improbable locations for the asset tag 261. For example, and as previously mentioned, the locationing engine 110b2 may define and analyze each zone 262a-f, 264a-f, 266a-f, 268a-f based on one or more polylines in 3D space. These polylines may be represented by the edges of the respective zones 262a-f, 264a-f, 266a-f, 268a-f illustrated in the zone map 260. The location of the asset tag 261 may then be a set of 3D coordinates within the 3D space, and the locationing engine 110b2 may compare the set of 3D coordinates with polylines of the current zone. The locationing engine 110b2 may determine that the set of 3D coordinates is bounded by the polylines of the current zone (e.g., third zone 266c), and the engine 110b2 may also determine that the asset tag 261 is located within the current zone.

For example, the third zone 266c may be defined by at least four polylines constructing a rectangular shape in 3D space. The rectangular shape representing the third zone 266c may have dimensions in a predefined coordinate plane (ordered as X, Y, Z) that may include any objects within the dimensional ranges of (−10 to −5, 12 to 21, 0 to 10). The asset tag 261 may have a 3D location of (−6.2, 14, 3.8), such that the locationing engine 110b2 may determine that the asset tag 261 is located within the polylines of the third zone 266c and is therefore located in the third zone 266c.

In certain embodiments, locationing engine 110b2 may also establish a set of checkpoints corresponding to the plurality of zones 262a-f, 264a-f, 266a-f, 268a-f that may act as intermediate travel paths for transitioning between zones. The locationing engine 110b2 may then compare (i) the time differential, (ii) the associated confidence value, and (iii) the set of checkpoints with the cost value; and update the location of the tag based on the comparison.

For example, the first set of zones 262a-f may be on a separate floor from each of the second set of zones 264a-f, the third set of zones 266a-f, and the fourth set of zones 268a-f. Thus, to reach the zone 264a from the zone 262a, the asset tag 261 must descend through either a staircase or an elevator. The staircase and/or the elevator (or other suitable mechanism for transitioning between floors) may therefore be defined and/or otherwise act as a checkpoint to validate the asset tag 261 moving between any zone in the first set of zones 262a-f and any zone in the second set of zones 264a-f. Similarly, to reach any zone in the third set of zones 266a-f and/or the fourth set of zones 268a-f from any zone in the first set of zones 262a-f may require passing through two/three such checkpoints (staircases, elevators, etc.) to represent a probable/valid movement. If, for example, the asset tag 261 appears to move from the first zone 262a to the fourth zone 268f without passing through any checkpoints, the locationing engine 110b2 may suppress and/or otherwise filter out this movement because the asset tag 261 moving from a first floor (e.g., corresponding to first zone 262a) to a fourth floor (e.g., corresponding to fourth zone 268f) without utilizing a staircase, elevator, etc. is highly improbable.

In some instances, the locationing engine 110b2 may evaluate AOA signals/confidence values based on free movement areas between certain zones. Such zones joined by and/or otherwise including free movement areas may be, for example, located in a single room and/or otherwise can be moved between in relatively minimal or negligible time. For example, the first zone 262a may have a free movement area 272 along a perimeter of the first zone 262a that is adjacent to the zone 264a, such that moving between the first zone 262a and the zone 264a incurs and/or otherwise has no associated cost value. The locationing engine 110b2 may determine that the asset tag 110b2 moved between the first zone 262a and the third zone 266c along the second path 270b by, in part, moving through the free movement area 272. The locationing engine 110b2 may then reduce, eliminate, and/or otherwise adjust the cost value associated with moving from the first zone 262a to the third zone 266c by accounting for the asset tag 261 moving through the free movement area 272.

Using these factors, among others, the improbable location filtering process illustrated in FIG. 2B enables the underlying locationing system to determine the asset tag 261 location with significant accuracy and precision to a degree that was previously unachievable using conventional techniques.

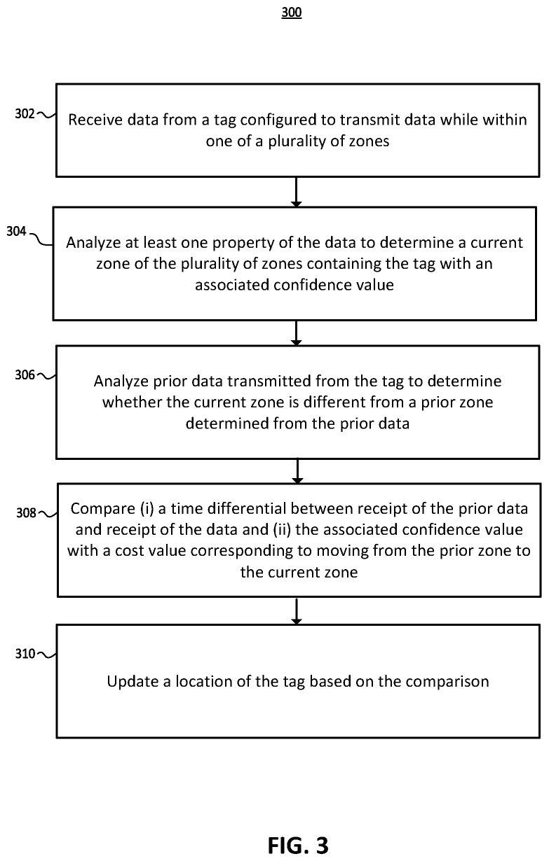

FIG. 3 is a flowchart representative of a method 300 for filtering improbable locations, in accordance with embodiments described herein. Generally, and as described herein, the method 300 for filtering improbable locations may cause the server 110, anchor 102, and/or any tags (e.g., tags 106a1, 107a1, 108a1, 202a1, 202b1, 202c1) to determine probable locations for tags by suppressing and/or otherwise filtering improbable locations. More specifically, the method 300 enables the server 110, the anchor 102, and the tags (e.g., tags 106a1, 107a1, 108a1, 202a1, 202b1, 202c1) to enhance/improve the accuracy of asset locationing/tracking by determining confidence values for reported data packets and corresponding estimated tag locations and applying cost values to those confidence values, as described herein. It is to be understood that any of the steps of the method 300 may be performed by, for example, the server 110, the anchor 102, tags (e.g., tags 106a1, 107a1, 108a1, 202a1, 202b1, 202c1), and/or any other suitable components or combinations thereof discussed herein.

At block 302, the method 300 includes receiving data from a tag configured to transmit data while within one of a plurality of zones. At block 304, the method 300 includes analyzing at least one property of the data to determine a current zone of the plurality of zones containing the tag with an associated confidence value. At block 306, the method 300 includes analyzing prior data transmitted from the tag to determine whether the current zone is different from a prior zone determined from the prior data. At block 308, the method 300 includes comparing (i) a time differential between receipt of the prior data and receipt of the data and (ii) the associated confidence value with a cost value corresponding to moving from the prior zone to the current zone. At block 310, the method 300 includes updating a location of the tag based on the comparison.

In certain embodiments, the at least one property of the data includes a received signal strength indicator (RSSI) value, and the method 300 further comprises: determining the associated confidence value based on the RSSI value. Further in these embodiments, the method 300 may further comprise: determining, for the tag, at least one of: (a) a number of different zone reports, (b) a number of consecutive zone reports for the current zone, or (c) a confidence value adjustment for the current zone based on the RSSI value; and adjusting the associated confidence value based on one or more of (a)-(c).

The number of different zone reports may generally refer to an overall number of different zones in which the tag has been located as a basis for longer-term likelihood comparisons. For example, tag 1 may have been reported in zone 1 one million times, zone 2 ten times, and zone 3 one time. Therefore, the locationing engine 110b2 may determine that it is more likely that tag 1 is in zone 1 at any given time than either zone 2 or 3 because tag 1 has been in zone 1 a significantly greater number of times than in either zone 2 or 3.

Further, the number of consecutive zone reports may inform the locationing engine 110b2 as to which zone a tag is likely located in based on the tag's most recent location(s). For example, assume that tag 1 reported being located in zone 1 during the prior 10,000 reports, and in the most recent report, tag 1 reports being located in far-away zone 6. Also assume that either the current zone 6 report or the prior zone 1 report is erroneous. In this example, the locationing engine 110b2 may determine that the zone 6 report is more likely to be erroneous/improbable than the zone 1 report because the tag has recently and consistently been located in zone 1.

In some embodiments, each zone of the plurality of zones is defined by one or more polylines in three-dimensional (3D) space, the location of the tag is a set of 3D coordinates within the 3D space, and the method 300 may further comprise: comparing the set of 3D coordinates with polylines of the current zone; determining that the set of 3D coordinates is bounded by the polylines of the current zone; and determining that the tag is located within the current zone.

In certain embodiments, the cost value is an average travel time from the prior zone to the current zone. However, it should be appreciated that the cost value may be any suitable value calculated in accordance with any suitable paradigm, such as a median travel time, a shortest possible estimated travel time, and/or any other suitable technique or combinations thereof.

In some embodiments, the method 300 may further comprise: reducing the cost value based on a respective confidence value associated with the tag being located within the prior zone; and updating the location of the tag based on reducing the cost value and the comparison.

In certain embodiments, the method 300 may further comprise: establishing a set of checkpoints corresponding to the plurality of zones; comparing (i) the time differential, (ii) the associated confidence value, and (iii) the set of checkpoints with the cost value; and updating the location of the tag based on the comparison.

In some embodiments, the prior zone has a free movement area along a perimeter of the prior zone, and the method 300 may further comprise: determining that the tag moved between the prior zone and the current zone through the free movement area; eliminating the cost value; and updating the location of the tag based on the associated confidence value.

Of course, it is to be appreciated that the actions of the method 300 may be performed in any suitable order and any suitable number of times.

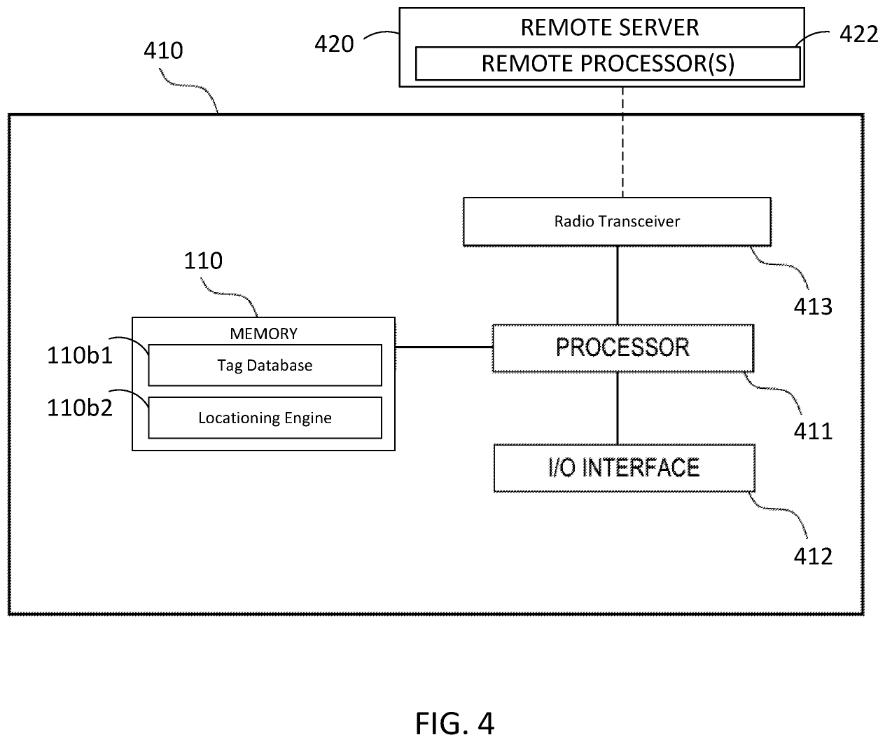

FIG. 4 is a block diagram representative of an example logic circuit capable of implementing example methods and/or operations described herein. As an example, the example logic circuit may be capable of implementing one or more components of the server 110 of FIG. 1. Of course, it should be understood that the example logic circuit may also include and/or otherwise access instructions and/or components of other components represented in FIG. 1 and/or elsewhere herein, such as the anchor 102, tags (e.g., tags 106a1, 107a1, 108a1, 202a1, 202b1, 202c1) and the like.

The example logic circuit of FIG. 4 is a processing platform 410 capable of executing instructions to, for example, implement operations of the example methods described herein, as may be represented by the flowcharts of the drawings that accompany this description. Other example logic circuits capable of, for example, implementing operations of the example methods described herein include field programmable gate arrays (FPGAs) and application specific integrated circuits (ASICs).

The example processing platform 410 of FIG. 4 includes a processor 411 such as, for example, one or more microprocessors, controllers, and/or any suitable type of processor. The example processing platform 410 of FIG. 4 includes memory (e.g., volatile memory, non-volatile memory) 110 accessible by the processor 411 (e.g., via a memory controller). The example processor 411 interacts with the memory 110 to obtain, for example, machine-readable instructions stored in the memory 110 corresponding to, for example, the operations represented by the flowcharts of this disclosure. The memory 110 also includes the tag database 110b1 and the locationing engine 110b2 that are accessible by the example processor 411.

The locationing engine 110b2 may comprise rule-based instructions configured to, for example, cause the example processor 411 to analyze data received from tags to update locations of the tags. More specifically, the locationing engine 110b2 may comprise rule-based instructions configured to cause the example processor 411 to analyze data packets and/or information extracted and/or otherwise derived from the data packets to determine a current zone in which each tag is currently located. The locationing engine 110b2 may further comprise rule-based instructions configured to, for example, cause the example processor 411 to determine the current zone by calculating/adjusting confidence values based on time differentials and cost values, among other values or combinations thereof.

To illustrate, the example processor 411 may access the memory 110 to execute, reference, and/or otherwise interpret the tag database 110b1 and/or the locationing engine 110b2 when receiving AOA signals from an anchor. Additionally, or alternatively, machine-readable instructions corresponding to the example operations described herein may be stored on one or more removable media (e.g., a compact disc, a digital versatile disc, removable flash memory, etc.) that may be coupled to the processing platform 410 to provide access to the machine-readable instructions stored thereon.

The example processing platform 410 of FIG. 4 also includes a radio transceiver 413 to enable communication with other machines via, for example, one or more networks. The example radio transceiver 413 includes any suitable type of communication interface(s) (e.g., wired and/or wireless interfaces) configured to operate in accordance with any suitable protocol(s) (e.g., Ethernet for wired communications, and/or BLE or IEEE 802.11 for wireless communications).

The example processing platform 410 of FIG. 4 also includes input/output (I/O) interfaces 412 to enable receipt of user input and communication of output data to the user. Such user input and communication may include, for example, any number of keyboards, mice, USB drives, optical drives, screens, touchscreens, etc.

Further, the example processing platform 410 may be connected to a remote server 420. The remote server 420 may include one or more remote processors 422, and may be configured to execute instructions to, for example, implement operations of the example methods described herein, as may be represented by the flowcharts of the drawings that accompany this description.

### ADDITIONAL CONSIDERATIONS

The above description refers to a block diagram of the accompanying drawings. Alternative implementations of the example represented by the block diagram includes one or more additional or alternative elements, processes and/or devices. Additionally, or alternatively, one or more of the example blocks of the diagram may be combined, divided, re-arranged or omitted. Components represented by the blocks of the diagram are implemented by hardware, software, firmware, and/or any combination of hardware, software and/or firmware. In some examples, at least one of the components represented by the blocks is implemented by a logic circuit. As used herein, the term “logic circuit” is expressly defined as a physical device including at least one hardware component configured (e.g., via operation in accordance with a predetermined configuration and/or via execution of stored machine-readable instructions) to control one or more machines and/or perform operations of one or more machines. Examples of a logic circuit include one or more processors, one or more coprocessors, one or more microprocessors, one or more controllers, one or more digital signal processors (DSPs), one or more application specific integrated circuits (ASICs), one or more field programmable gate arrays (FPGAs), one or more microcontroller units (MCUs), one or more hardware accelerators, one or more special-purpose computer chips, and one or more system-on-a-chip (SoC) devices. Some example logic circuits, such as ASICs or FPGAs, are specifically configured hardware for performing operations (e.g., one or more of the operations described herein and represented by the flowcharts of this disclosure, if such are present). Some example logic circuits are hardware that executes machine-readable instructions to perform operations (e.g., one or more of the operations described herein and represented by the flowcharts of this disclosure, if such are present). Some example logic circuits include a combination of specifically configured hardware and hardware that executes machine-readable instructions. The above description refers to various operations described herein and flowcharts that may be appended hereto to illustrate the flow of those operations. Any such flowcharts are representative of example methods disclosed herein. In some examples, the methods represented by the flowcharts implement the apparatus represented by the block diagrams. Alternative implementations of example methods disclosed herein may include additional or alternative operations. Further, operations of alternative implementations of the methods disclosed herein may combined, divided, re-arranged or omitted. In some examples, the operations described herein are implemented by machine-readable instructions (e.g., software and/or firmware) stored on a medium (e.g., a tangible machine-readable medium) for execution by one or more logic circuits (e.g., processor(s)). In some examples, the operations described herein are implemented by one or more configurations of one or more specifically designed logic circuits (e.g., ASIC(s)). In some examples the operations described herein are implemented by a combination of specifically designed logic circuit(s) and machine-readable instructions stored on a medium (e.g., a tangible machine-readable medium) for execution by logic circuit(s).

As used herein, each of the terms “tangible machine-readable medium,” “non-transitory machine-readable medium” and “machine-readable storage device” is expressly defined as a storage medium (e.g., a platter of a hard disk drive, a digital versatile disc, a compact disc, flash memory, read-only memory, random-access memory, etc.) on which machine-readable instructions (e.g., program code in the form of, for example, software and/or firmware) are stored for any suitable duration of time (e.g., permanently, for an extended period of time (e.g., while a program associated with the machine-readable instructions is executing), and/or a short period of time (e.g., while the machine-readable instructions are cached and/or during a buffering process)). Further, as used herein, each of the terms “tangible machine-readable medium,” “non-transitory machine-readable medium” and “machine-readable storage device” is expressly defined to exclude propagating signals. That is, as used in any claim of this patent, none of the terms “tangible machine-readable medium,” “non-transitory machine-readable medium,” and “machine-readable storage device” can be read to be implemented by a propagating signal.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of teachings. Additionally, the described embodiments/examples/implementations should not be interpreted as mutually exclusive, and should instead be understood as potentially combinable if such combinations are permissive in any way. In other words, any feature disclosed in any of the aforementioned embodiments/examples/implementations may be included in any of the other aforementioned embodiments/examples/implementations.

The benefits, advantages, solutions to problems, and any element(s) that may cause any benefit, advantage, or solution to occur or become more pronounced are not to be construed as a critical, required, or essential features or elements of any or all the claims. The claimed invention is defined solely by the appended claims including any amendments made during the pendency of this application and all equivalents of those claims as issued.

Moreover, in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter may lie in less than all features of a single disclosed embodiment. Thus, the following claims are hereby incorporated into the Detailed Description, with each claim standing on its own as a separately claimed subject matter.

1. A system comprising:
a tag configured to transmit data while within one of a plurality of zones; and
a locationing engine configured to:
receive the data,
analyze at least one property of the data to determine a current zone of the plurality of zones containing the tag with an associated confidence value,
analyze prior data transmitted from the tag to determine whether the current zone is different from a prior zone determined from the prior data,
compare (i) a time differential between receipt of the prior data and receipt of the data and (ii) the associated confidence value with a cost value corresponding to moving from the prior zone to the current zone, and
update a location of the tag based on the comparison.

2. The system of claim 1, wherein the at least one property of the data includes a received signal strength indicator (RSSI) value, and the locationing engine is further configured to:
determine the associated confidence value based on the RSSI value.

3. The system of claim 2, wherein the locationing engine is further configured to:
determine, for the tag, at least one of: (a) a number of different zone reports, (b) a number of consecutive zone reports for the current zone, or (c) a confidence value adjustment for the current zone based on the RSSI value; and
adjust the associated confidence value based on one or more of (a)-(c).

4. The system of claim 1, wherein each zone of the plurality of zones is defined by one or more polylines in three-dimensional (3D) space, the location of the tag is a set of 3D coordinates within the 3D space, and the locationing engine is further configured to:
compare the set of 3D coordinates with polylines of the current zone;
determine that the set of 3D coordinates is bounded by the polylines of the current zone; and
determine that the tag is located within the current zone.

5. The system of claim 1, wherein the cost value is an average travel time from the prior zone to the current zone.

6. The system of claim 1, wherein the locationing engine is further configured to:
reduce the cost value based on a respective confidence value associated with the tag being located within the prior zone; and
update the location of the tag based on reducing the cost value and the comparison.

7. The system of claim 1, wherein the locationing engine is further configured to:
establish a set of checkpoints corresponding to the plurality of zones;
compare (i) the time differential, (ii) the associated confidence value, and (iii) the set of checkpoints with the cost value; and
update the location of the tag based on the comparison.

8. The system of claim 7, wherein each checkpoint of the set of checkpoints represents an intermediate travel path for transitioning between zones of the plurality of zones.

9. The system of claim 1, wherein the prior zone has a free movement area along a perimeter of the prior zone, and the locationing engine is further configured to:
determine that the tag moved between the prior zone and the current zone through the free movement area;
eliminate the cost value; and
update the location of the tag based on the associated confidence value.

10. A computer-implemented method comprising:
receiving data from a tag configured to transmit data while within one of a plurality of zones;
analyzing at least one property of the data to determine a current zone of the plurality of zones containing the tag with an associated confidence value;
analyzing prior data transmitted from the tag to determine whether the current zone is different from a prior zone determined from the prior data;
comparing (i) a time differential between receipt of the prior data and receipt of the data and (ii) the associated confidence value with a cost value corresponding to moving from the prior zone to the current zone; and
updating a location of the tag based on the comparison.

11. The computer-implemented method of claim 10, wherein the at least one property of the data includes a received signal strength indicator (RSSI) value, and the method further comprises:
determining the associated confidence value based on the RSSI value.

12. The computer-implemented method of claim 11, further comprising:
determining, for the tag, at least one of: (a) a number of different zone reports, (b) a number of consecutive zone reports for the current zone, or (c) a confidence value adjustment for the current zone based on the RSSI value; and
adjusting the associated confidence value based on one or more of (a)-(c).

13. The computer-implemented method of claim 10, wherein each zone of the plurality of zones is defined by one or more polylines in three-dimensional (3D) space, the location of the tag is a set of 3D coordinates within the 3D space, and the method further comprises:
comparing the set of 3D coordinates with polylines of the current zone;
determining that the set of 3D coordinates is bounded by the polylines of the current zone; and
determining that the tag is located within the current zone.

14. The computer-implemented method of claim 10, wherein the cost value is an average travel time from the prior zone to the current zone.

15. The computer-implemented method of claim 10, further comprising:
reducing the cost value based on a respective confidence value associated with the tag being located within the prior zone; and
updating the location of the tag based on reducing the cost value and the comparison.

16. The computer-implemented method of claim 10, further comprising:
establishing a set of checkpoints corresponding to the plurality of zones;
comparing (i) the time differential, (ii) the associated confidence value, and (iii) the set of checkpoints with the cost value; and
updating the location of the tag based on the comparison.

17. The computer-implemented method of claim 10, wherein the prior zone has a free movement area along a perimeter of the prior zone, and the method further comprises:
determining that the tag moved between the prior zone and the current zone through the free movement area;
eliminating the cost value; and
updating the location of the tag based on the associated confidence value.

18. A tangible machine-readable medium comprising instructions that, when executed, cause a machine to at least:
receive data from a tag configured to transmit data while within one of a plurality of zones;
analyze at least one property of the data to determine a current zone of the plurality of zones containing the tag with an associated confidence value;
analyze prior data transmitted from the tag to determine whether the current zone is different from a prior zone determined from the prior data;
compare (i) a time differential between receipt of the prior data and receipt of the data and (ii) the associated confidence value with a cost value corresponding to moving from the prior zone to the current zone; and
update a location of the tag based on the comparison.

19. The system of claim 1, wherein the at least one property of the data includes a received signal strength indicator (RSSI) value, and the instructions, when executed, further cause the machine to at least:
determine the associated confidence value based on the RSSI value.

20. The system of claim 1, wherein the cost value is an average travel time from the prior zone to the current zone, and the instructions, when executed, further cause the machine to at least:
reduce the cost value based on a respective confidence value associated with the tag being located within the prior zone; and
update the location of the tag based on reducing the cost value and the comparison.
